(19) United States
(12) Patent Application Publication
(10) Pub. No.: US 2019/0191868 A1
(43) Pub. Date: Jun. 27, 2019

(54) MODULAR TABLE WITH ANGLED LEG COUPLER

(71) Applicant: William Bowser, Park City, UT (US)

(72) Inventor: William Bowser, Park City, UT (US)

(21) Appl. No.: 16/218,059

(22) Filed: Dec. 12, 2018

Related U.S. Application Data
(60) Provisional application No. 62/608,943, filed on Dec. 21, 2017.

(51) Int. Cl. A47B 13/00; F16B 12/42

(52) U.S. Cl. CPC A47B 13/003; F16B 12/42

(57) ABSTRACT

The present invention contemplates a unique and novel system and method for selectively, modularly, removably coupling table legs to a table top to form a table assembly using a unique coupling assembly. The coupling assembly is comprised of a mounting nut that mounts within the table top. A coupler has table legs mounted thereon, forming a table leg assembly. An attachment member, such as a wing screw, selectively, removably attaches the coupler of the table leg assembly to the mounting nut. An alignment member attached to the table top contacts the coupler and prevents the coupler, and therefore the table leg assembly, from rotating. The coupling assembly enables a quick coupling or decoupling of the table leg assembly to the table top, such that the table top and table leg assembly can be conveniently stored, then set up, then taken down and stored again on a continual basis.

### RELATED APPLICATION

This non-provisional patent application claims priority to and the benefit of U.S. Provisional Patent Application No. 62/608,943, filed Dec. 21, 2017 to William Bower, entitled “Modular Table with Angled Leg Coupler,” which is incorporated herein by reference.

### BACKGROUND OF THE INVENTION

### 1. The Field of the Invention

This invention is in the field of modular tables.

### 2. The Relevant Technology

Event management is a busy and complex business. Event managers must be ready for events having a number of different sizes—small, medium and large. Small events often use less furnishings, while the large events can tax the staff and resources of even a successful events manager. Events managers are required to have the ability to provide furnishings for all such events. Thus, storage, set-up and management of furnishings becomes an important logistical venture.

As storage space becomes more of a challenge, there is increasing motivation to improve the type of modular, storable furnishings that can be used. Furnishings that can be used both for small, medium, and large events and that are readily stored and set-up the next week are particularly useful. Thus, there is a significant need for modular tables that can be used for one portion of the table, and/or for another portion of a table, depending upon a particular need.

Modular table assemblies can be employed at an end of a table, at the middle of a table, on the side of a table or in a variety of different positions, as necessary, in a particular occasion. Modular tables are particularly useful when they can be decreased in size in order to be stored, and then increase in size in order to be used. One challenge is that folding tables, which can be readily folded up or down, depending upon a particular need, often do not have a pleasing aesthetic appearance and often are not stable under a variety of different circumstances.

There is therefore a need in the table industry for an improved table that is aesthetically pleasing, can be readily stored, and can be readily used in a variety of non-storage settings when the need for use arises.

### BRIEF SUMMARY OF THE INVENTION

The present invention contemplates a unique and novel system and method for selectively, modularly, removably coupling table legs to a table top to form a table assembly using a unique coupling assembly. The coupling assembly is comprised of a mounting nut that mounts within the table top. A coupler has table legs mounted thereon, forming a table leg assembly. An attachment member, such as a wing screw, selectively, removably attaches the coupler of the table leg assembly to the mounting nut. An alignment member attached to the table top contacts the coupler and prevents the coupler, and therefore the table leg assembly, from rotating.

The coupling assembly enables a quick coupling or decoupling of the table leg assembly to the table top, such that the table top and table leg assembly can be conveniently stored, then set up, then taken down and stored again on a continual basis.

More specifically, an embodiment of a “coupling assembly” of the present invention for coupling table legs to a substantially flat table top of a modular table comprises: (A) a mounting nut configured to be secured to the table top (e.g., at least partially embedded within the table top), the mounting nut having a neck and a shoulder mounted about the neck, the neck configured to extend through a portion of the table top such that a portion of the neck of the mounting nut extends out of a surface of the table top; (B) a coupler having a substantially flat plate, the coupler further having first and second opposing flanges extending from opposing portions of a first side of the plate, the first and second flanges extending at an angle away from a plane defined by the substantially flat plate, the coupler further having a buttress support member extending between the first and second flange members outwardly away from the plate within the same plane as the plate, the flange and buttress support members configured such that the table legs of the table assembly can be mounted on respective flanges and the buttress support member, the coupler further having an aperture through which the neck of the mounting nut at least partially extends; (C) an attachment member, such as a wing-screw, that selectively, removably extends into the neck of the mounting nut, thereby selectively, removably connecting the coupling plate of the coupler to the mounting nut, such that the table leg assembly is coupled to the table top; and (D) an alignment member configured to be mounted within the table top and extend at least partially through a second aperture in the plate of the coupler, the alignment member preventing rotation of the table leg assembly.

A table leg coupler of the present invention comprises: (i) a substantially flat plate, having a first aperture therein, the plate having a first side and a second side; (ii) first and second flanges extending from opposing ends of the first side of the plate; and (iii) a buttress member extending outwardly from the first side of the plate between the first and second flanges, the buttress member extending outwardly from the plate in the same plane as the plate, (iv) such that the plate and the buttress member can be mounted flush with a substantially flat bottom surface of a table top, (v) such that first and second parallel table support legs can be supported by the first and second flange members, respectively, and (vi) such that the buttress member supports a buttress leg that is off-set at its table-top end from the first and second table support legs.

The flanges extend at an angle of approximately 97 degrees, in one embodiment, with respect to the plane of the plate. The buttress support member extends, in the same plane as the plate, away from the plate. The coupler connects to first and second parallel legs that couple to the flanges. The buttress support couples to a buttress leg that extends away from the buttress support. The parallel support legs and buttress leg meet at a support member that contacts the floor. The floor support member couples the legs together at the floor support member.

The floor support member couples the three legs together at one end of the legs, and the coupler couples the three legs to the coupler at an opposing end of the legs. An attachment member such as a winged screw extends into a circularly-shouldered nut member coupled into the table top, attaching the coupler (and the legs attached thereto) to the table top. A variety of different variations can be employed, as discussed herein.

Thus, in one embodiment, a modular table assembly employing the unique coupler of the present invention comprises: (i) a substantially flat table top; (ii) a plurality of mounting nut members embedded within the table top, the mounting nut members each having a neck member, a portion of which extends out of the surface of the table top; and (iii) a plurality of table leg assemblies (including legs and respective couplers) that are selectively mounted onto the table top, the neck of a respective mounting nut extending through a portion of each of the couplers of each of the respective leg assemblies when the respective leg assemblies are mounted onto the table top.

The table leg assemblies are mounted to the table top(s) at angles with respect to the table tops that increase the stability of the resulting tables. These angles are achieved through the use of the couplers of the present invention having angled flanges.

The table leg assemblies that support the table top each include a coupler, each of the couplers having an aperture therethrough that receives a neck of a respective mounting nut at least partially therethrough, the mounting of the plate onto the neck of the mounting nut providing stability to each of the table leg assemblies.

An attachment member, e.g., a wing screw connects to the plate of the coupler and the mounting nut by extending through the mounting plate and into the neck of the mounting nut. Thus, the combination of the wing screw and the mounting nut are examples of two-part attachment members that are employed in the present invention.

One advantage of the present invention is the table leg assemblies can be used to support a variety of different table tops having a variety of different shapes. By mounting a plurality of attachment members, such as for example, mounting nut members, at universal offset distances “D” (e.g., 7.5 inches) from the edges of respective table tops, the table tops can be conveniently coupled together with table top connectors that span a universal connector distance 2D (e.g., 15 inches). The “universal connector distance” is at least twice and possibly greater than twice the universal offset distance, i.e., because the universal offset distance of two tables is being spanned by the connector.

The modularity of the table top connectors and the table leg assemblies also enables a variety of unique, interesting, and helpful types of furniture assemblies to be created, such as simple one-leaf tables, two-leaf banquet tables, circular tables, rectangular tables, square tables, desks, tables with holes in the center for flower arrangements, center pieces, standing tables, and Lazy Susan type serving tables, tables with corresponding benches, U-shaped tables, oval tables, stacked tables, cocktail tables and tables and furniture arrangements having a variety of shapes and sizes.

Because of the convenient modularity of the pieces involved, the table assembly of the present invention can be conveniently assembled and used, then conveniently disassembled and stored in a closet or store room when not in use. For convenient storage and transportation, the leg assemblies conveniently nest into each other because of their unique configuration.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 demonstrates a table 10 of the present invention. Couplers of the table leg assemblies (which in one embodiment are identical or substantially similar) are shown in dotted phantom lines for illustrative purposes.

FIG. 2A is a view of a rectangular table top of the table 10 of FIG. 1.

FIG. 2B is an alternate semicircular table top of the present invention.

FIG. 3 is an exploded view of the underside of table 10 of FIG. 1.

FIG. 4 is an assembled view of the underside of table 10 of FIG. 1.

FIGS. 5A and 5B are alternate upper and lower views of the coupler of the table 10 of FIG. 1.

FIGS. 6 and 7 are exploded views of the leg assembly of the table 10 of FIG. 1.

FIGS. 8 and 9 are assembled views of the leg assembly of the table 10 of FIG. 1.

FIG. 10 shows two tables 10 that are combined to form a banquet table; the two tables 10 are coupled together using a table top connector.

FIG. 11 shows a table top connector employed to couple the tables in FIG. 10 (and in other figures) together.

FIG. 12 illustrates the coupling of the two tables 10, as shown in FIG. 10, using the coupler of FIG. 11.

FIG. 13 shows the underside of the coupled two tables of FIGS. 10 and 12.

FIG. 14 shows the two coupled tables 10 of FIG. 10 combined to form a larger table top with at least one bench having the dimensions and design of the table top 12 of FIG. 1. The table top 12 can thus be conveniently used as a bench or as part of a table top. The leg assemblies of the bench are smaller in height than those shown in FIG. 1 and FIG. 10.

FIGS. 15-16 show the nesting of table leg assemblies having the design of the leg assemblies of FIG. 1, which is convenient for storage and/or transportation.

FIGS. 17-21 illustrate various possible modular table configurations using the table top connectors of the present invention. Mounting nut members 20 are located at a universal offset distance “D” from the edges of the table tops such that the table top connectors having a length of at least and possibly greater than 2D can span adjacent table edges to connect adjacent table tops together.

FIGS. 22-23 illustrate a rotating serving table (e.g., a Lazy Susan-style rotating table) of the present invention being employed within a large table assembly of the present invention, e.g., with the table assembly of FIG. 21.

Additional Figures and description relating to the inventions herein are disclosed in U.S. Provisional Patent Application No. 62/608,943, filed Dec. 21, 2017 to William Bower, entitled “Modular Table with Angled Leg Coupler, which is incorporated herein by reference.

### DETAILED DESCRIPTION OF THE PREFERRED EMBODIMENTS

The present invention relates to a modular table assembly having a unique coupler that enables both convenient modularity, removability and stability of a table leg assembly as the coupler connects a table leg assembly to a table top. A number of unique and uniquely positioned attachment members and other components combine to achieve a highly modular, useful, and readily storable series of table assemblies, a large variety of which can be achieved, as discussed herein.

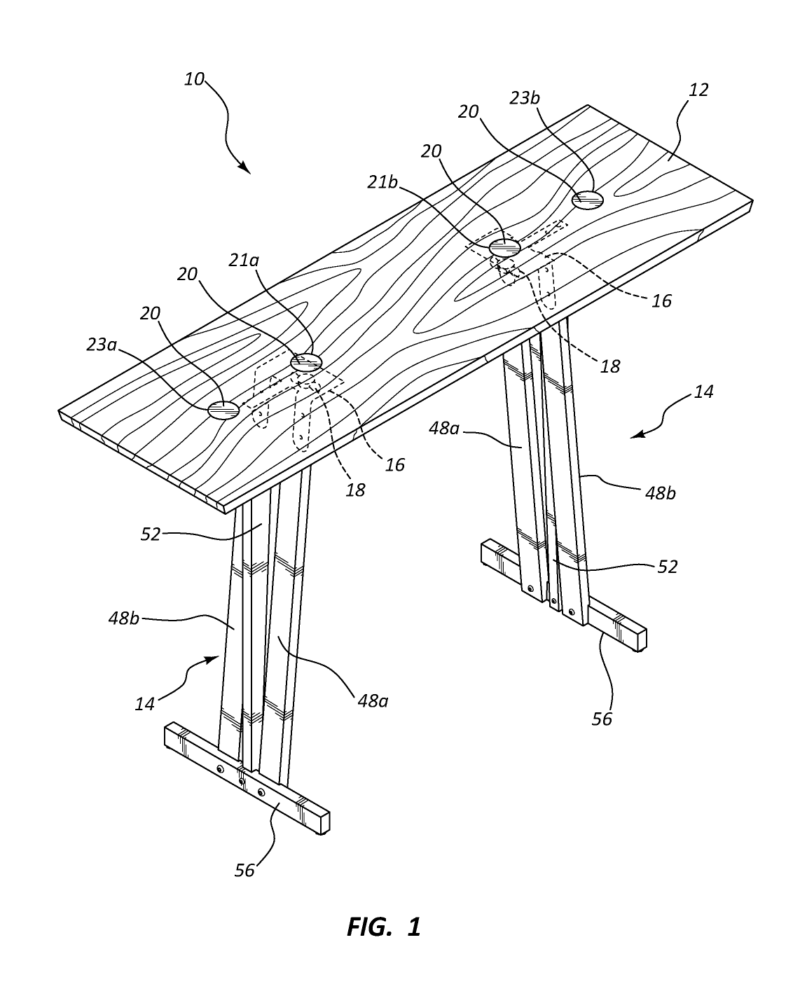

FIG. 1 shows a modular table 10 of the present invention. Modular table 10 is comprised of a table top 12, and first and second leg assemblies 14, the leg assemblies 14 having first and second respective couplers 16 that couple the leg assembles 14 to the table top 12. Leg assemblies 14 are coupled to table top 12 at angles with respect to table top 12, making the resulting table 10 of FIG. 1 stable and reliable. Leg assemblies 14 are angled at desired angles with respect to table top 12 through the use of angled portions (e.g., flanges) of couplers 16.

Corresponding two-part attachment members for enabling the connection of the couplers 16 of the leg assemblies 14 to the table top 12 of the table 10 are shown in FIGS. 1-3, such as: (i) winged screws 18 that selectively thread through plates of respective coupling members 16 and into (ii) respective nut members 20.

Nut members 20 have neck portions 25 that extend through table top 12 and through portions of respective couplers 16 in mating relationships with respective winged screws 18. Thus, the nut members 20 and wing screws are convenient members of the two-part attachment member system employed in the present invention.

With respect to FIGS. 1-3, nut members 20 are embedded within respective apertures 21a-b and 23a-b in table top 12. These different aperture locations shown in table top 12 of FIG. 1 provide different leg assembly coupling locations such that the leg assemblies can be placed in different desired locations on a table top. Respective holes 21a-b and 23a-b receive portions of respective mating two-part attachment members, e.g., nut members 20, there-through, into which wing screws 18 are mounted. In FIG. 1, table leg assemblies 14 are attached to nut members 20 in holes 21a-b. In another embodiment, nut members 20 in alternate holes 23a, 23b may be attached to in the event that it is desired to spread the leg assembly members 14 out further for different types of seating.

Holes 21a-b and 23a-b are each configured to be a universal offset distance “D” from a respective edge of table top 12 and can be employed to connect various table tops 12 together, as shown in later Figures.

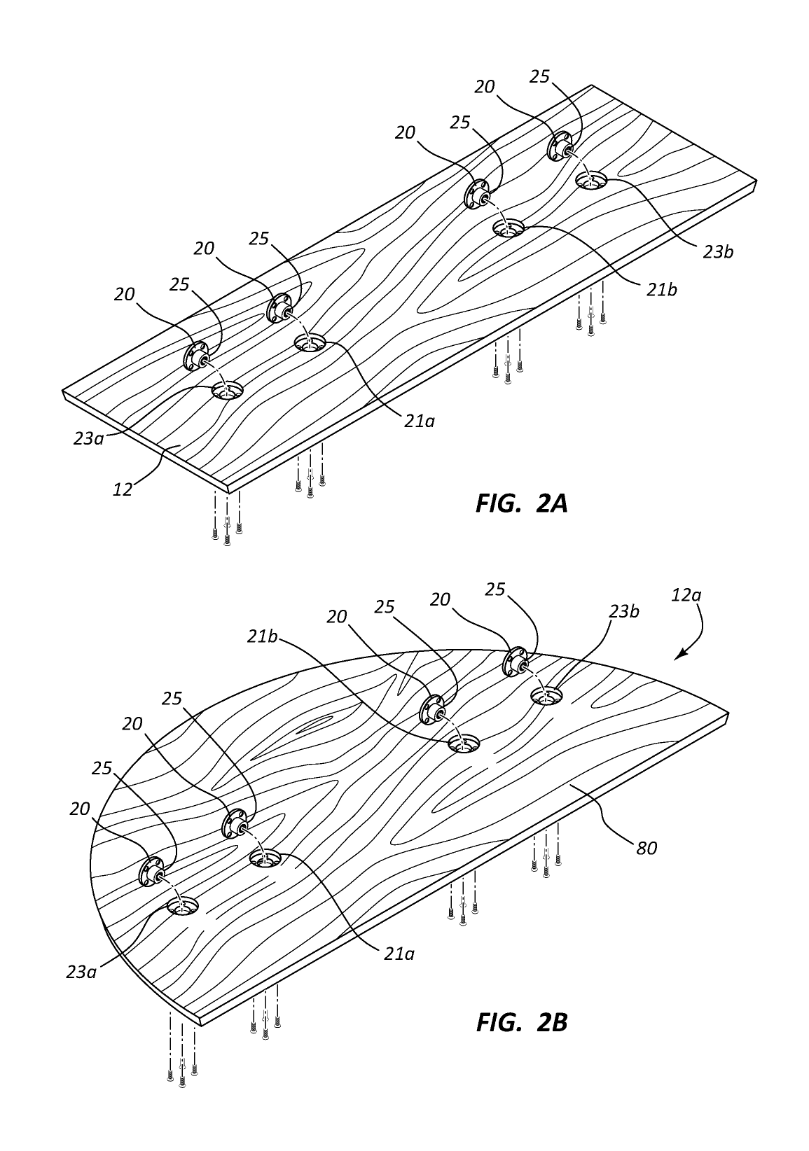

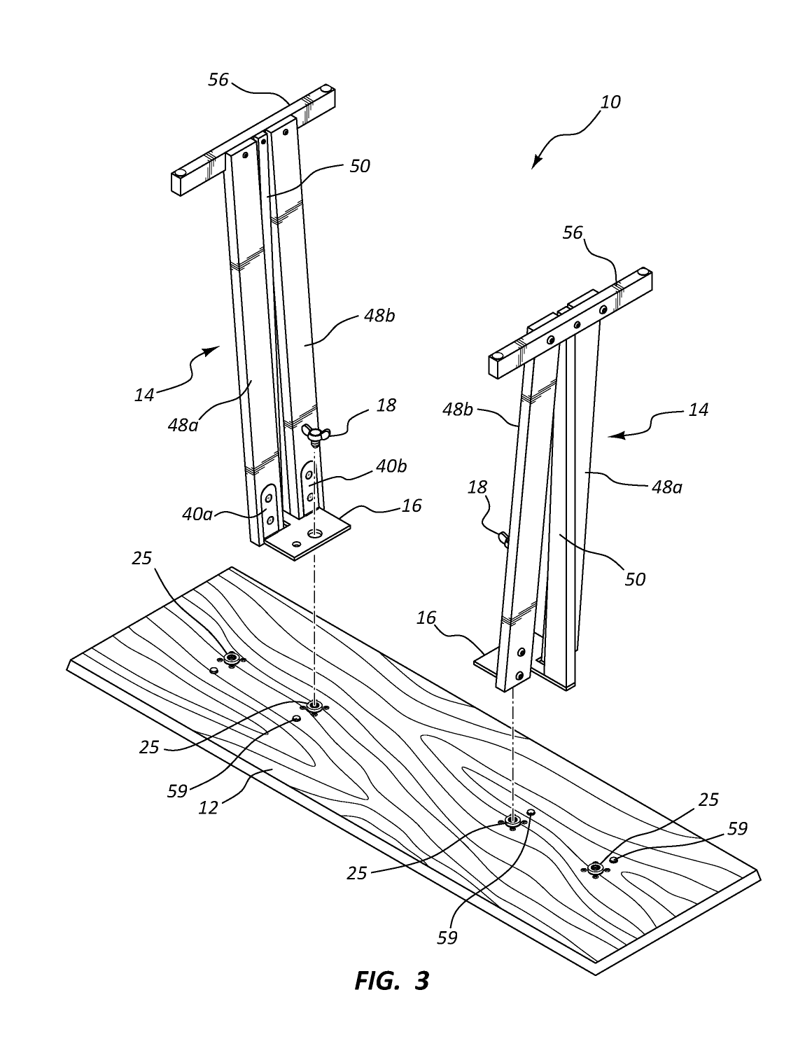

Nut members 20 each comprise a circular shoulder member connected to an internally threaded circular neck 25. As shown in FIG. 2A, the shoulder member has internal threads that receive securement screws through table top 12. The securement screws are threaded through the underside surface of the table top 12 into the shoulders of respective nut members 20 to retain the nut members 20 in the table top 12, as shown in FIGS. 2A-2B.

FIGS. 3-4 and 12 show the relationships of the winged screws threading through the respective couplers 16 into the internally threaded necks 25 of respective nut members 20.

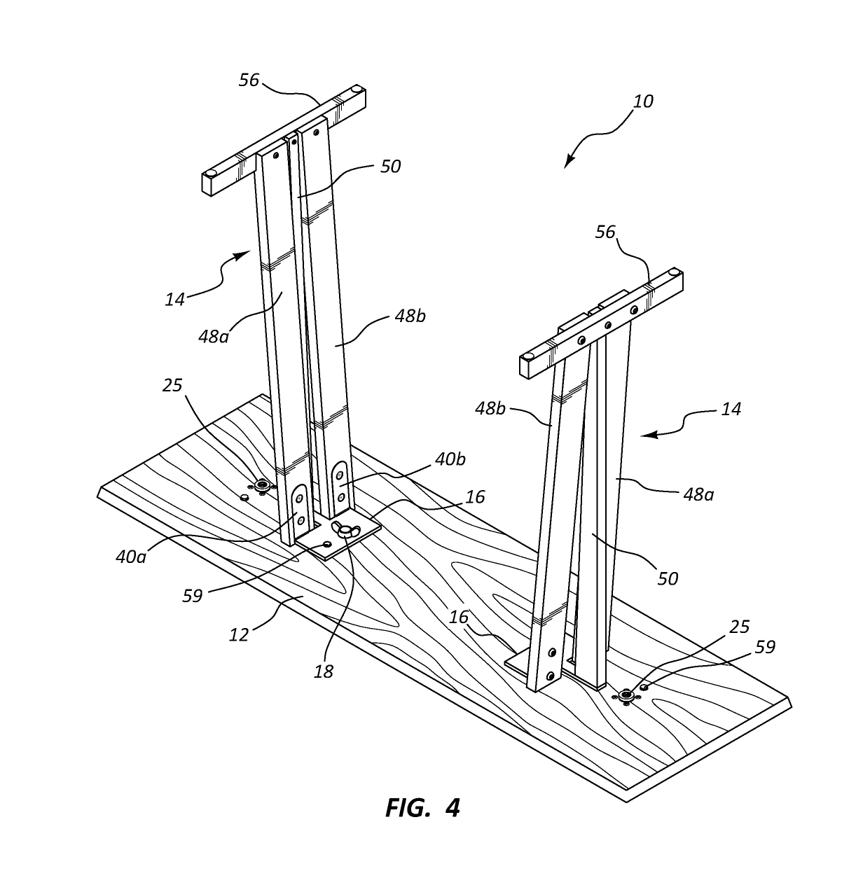

As shown in FIGS. 3-4, the connection of the leg assemblies 14 to the table top 12 using couplers 16 is very convenient and very efficient, e.g., simply using the wing screws 18 or other attachment members. The couplers 16 are conveniently selectively, removably mounted onto the table top 12 for convenient use. When an event is finished, and storage is desired, the entire assembly can be taken apart for convenient storage.

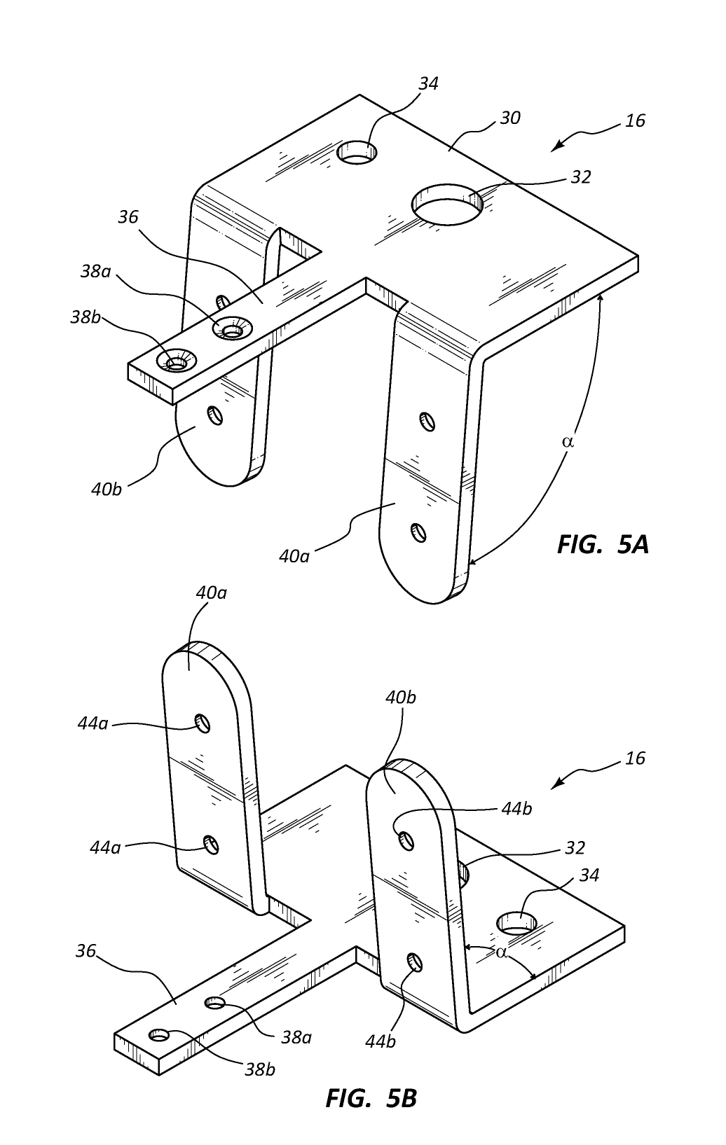

FIGS. 5A-B show details of the couplers 16 of the present invention. An example of a coupler 16 of the present invention is shown in FIGS. 5A-B and now will be described in additional detail. Coupler 16 (e.g., a metallic coupler) is comprised of a substantially flat plate 30 having a connecting aperture 32 therein and an orientation aperture 34 therein.

Extending laterally from plate 30 and in the same plane as plate 30, is a buttress support 36, having first and second apertures 38a, 38b therein. Buttress support 36 is configured to receive a buttress leg 50 (wooden, for example) which is secured to buttress support 36 through the use of screws (or other connectors) that thread through apertures 38a-b into the buttress support.

Extending at an angle α from plate 30 are first and second parallel angled flanges. Flanges 40a and 40b, as shown in FIGS. 5A-B, extend away from the plane of plate 30 at an angle α which, in one embodiment is 97 degrees or approximately 97 degrees from the plane of the plate 30 of coupler 16 as shown in FIGS. 5A-5B. This angled relationship enables coupling to support legs in a manner that provides excellent stability to the table of the present invention.

As shown in FIGS. 5A-B, each of the angled flanges 40a-40b has a respective pair of apertures 44a-44b therein. Screws extending through apertures 44a-44b connect parallel support legs 48a-b (wooden legs 48a-b, for example) to coupler 16 which extend away from coupler 16 at an angle with plate 30.

FIGS. 5A-B shows the angled relationship between first and second support flanges 40a and 40b and plate 30. In one embodiment, the flanges 40a-40b extend away at an angle α of 97 degrees with respect to the plane of the plate 30. In another embodiment, the angle α is approximately 97 degrees. In another embodiment, the angle α is in the range of approximately 95 degrees to approximately 99 degrees with respect to the plane of FIG. 30. In yet another embodiment, the angle α of the flanges extending with respect to plane of the plate 30 is in the range of approximately 91 degrees to approximately 105 degrees.

The coupler 16 provides stability in part because the coupler 16 is mounted flush with the table top 12 and provides useful components, e.g., the plate 30, the flanges 40a-b extending at an angle with respect to the plate and the buttress support 36 extending between the flanges within the same plane as the plate 30. In one embodiment the flanges 40a-b can be at an angle α of approximately 92 to approximately 105 degrees with respect to the plane of the plate. As a result of the angles provided by couplers 16, table leg assemblies 14 are angled with respect to table top(s) in a manner that makes the resulting table(s) stable. By angling the coupler flanges and therefore the support legs to which the coupler flanges are connected, the leg assemblies 14 are angled at supportive angles with respect to table top 12, as shown in FIGS. 1 and 4. The angles of leg assemblies 14 shown in FIGS. 1 and 4 provide reliability and stability to table 10. Also, the triangular relationship generated by the coupler 16 and legs 48a, 48b and 50 provides an excellent level of support and surface-area support to the table top 12, making the table 10 stable and reliable for the user.

As shown in FIGS. 1-3, the table 10 is stable and steady. The triangular relationship of the legs 48a-b, 50 of the leg assemblies 14 provides excellent support to the table top 12 and items resting thereon. Angling the leg assemblies 14 with respect to table top 12 and providing a triangular relationship amongst the leg members 48a, 48b, 50 provides steadiness and reliability to the table top 12.

With continued reference to FIGS. 5A-B and FIGS. 3-4, the second hole 34 in the plate 30 keeps coupler 16 from spinning by being mounted on the alignment screw 59 threaded into the underside of table top 12. In other embodiments, the alignment screw 59 may comprise any other alignment member that protrudes out of table top 12 so as to be received in hole 34 to minimize or prevent rotation of coupler 16. Positioning the hole 34 of plate 30 on alignment screw 59 maintains leg assembly 16 in a fixed position against table top 12, preventing or substantially preventing rotation of coupler 16 about neck 25 of nut member 20.

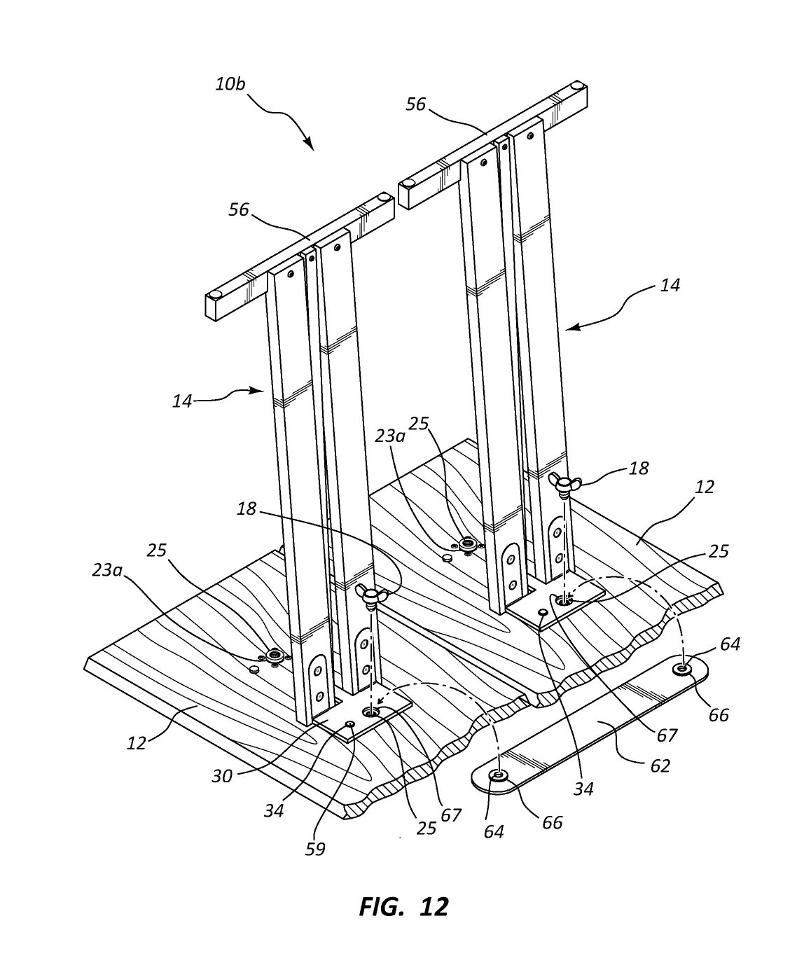

With reference to FIGS. 5A-B and FIG. 12, in one embodiment, the thickness of the plate 30 of coupler 16 (e.g., a metallic coupler) is approximately ¼ inch and the length of the neck 25 of the nut member 20 is approximately ½ inch. In an embodiment, a thickness of the tabletop sandwiched between the circular shoulder of nut member 20 and plate 30 of coupler 16 may be about 5/16 inch; in such an embodiment, neck 25 may protrude approximately 3/16 inch out of the plane of the table top 12, for receipt into receiving hole 32 of coupler 16, leaving an approximately 1/16 inch recessed space 67 within hole 32 of coupler.

Thus, when assembly of the table is desired, the receiving hole 32 of the coupler 16 is placed over the neck 25, leaving an approximately 1/16-inch recessed space 67 between the surface of the plate 30 and the portion of the neck 25 closest to the surface of the plate. In other words, the neck 25 is slightly sunken, e.g., an approximately 1/16-inch recessed space 67, within the plate 30.

Coupler 16 selectively mounts in mating relationship onto neck 25. When coupler 16 is mounted on neck 25, the protrusion of the neck 25 of the nut member 20 into the receiving hole 32 of the coupler 16 provides additional stability to assembly 14 in addition to the stability provided by the winged screw 18 that threadably couples the plate 30 to the table top 12. The plate 30 surrounds the neck 25 of the nut member 20, providing stability to the coupler 16 and the overall leg assembly 14 of which the coupler 16 is a part.

In one embodiment, the present invention employs the following: (i) wing-head screws 18 i.e., screws 18 with wings on the head portion for convenient insertion; and (ii) Acme threads on screws 18 for convenient threated mounting.

The present invention thus contemplates a coupling assembly for selectively, removably, coupling a leg assembly (comprising legs 48a, 48b, 50) of a modular table 10 to a table top 12 of the modular table 10. The coupling assembly is comprised of a mounting nut 20 that mounts within the table top 12. A coupler 16 has table legs 48a, 48b, 50 mounted thereon, forming a table leg assembly 14. An attachment member, such as a wing screw 18, selectively, removably attaches the coupler 16 of the table leg assembly 14 to the mounting nut 20. An alignment member 59 attached to the table top 12 contacts the coupler 16 and prevents the coupler 16, and therefore the table leg assembly 14, from rotating.

The coupling assembly enables a quick coupling or decoupling of the table leg assembly 14 to the table top 12, such that the table top 12 and table leg assembly 14 can be conveniently stored, then set up, then taken down and stored again on a continual basis. Assembly does not require any tools (e.g., screwdrivers, hammers, or the like). Assembly can be accomplished completely and easily by hand.

More specifically, one embodiment of a “coupling assembly” of the present invention for coupling table legs 48a, 48b, 50 to a substantially flat table top 12 of a modular table 10 comprises: (A) a mounting nut 20 configured to be secured to the table top 12 (e.g., at least partially embedded within the table top), the mounting nut 20 having a neck 25 and a shoulder mounted about the neck 25, the neck 25 configured to extend through a portion of the table top 12 such that a portion of the neck 25 of the mounting nut 20 extends out of a surface of the table top 12; (B) a coupler 16 having a substantially flat plate 30, the coupler 16 further having first and second opposing flanges 40a-b extending from opposing portions of a first side of the plate 30, the first and second flanges 40a-b extending at an angle away from a plane defined by the substantially flat plate 30, the coupler 16 further having a buttress support member 36 extending between the first and second flange members 40a-b outwardly away from the plate 30 within the same plane as the plate 30, the flange and buttress support members configured such that the table legs 48a-b, 50 of the table assembly 14 can be mounted on respective flanges 40a-b and the buttress support member 36, the coupler 14 further having an aperture 32 through which the neck 25 of the mounting nut 20 at least partially extends; (C) an attachment member, such as a wing-screw 18, that selectively, removably extends into the neck 25 of the mounting nut 20, thereby selectively, removably connecting the coupling plate 30 of the coupler 16 to the mounting nut 20, such that the table leg assembly 14 is coupled to the table top 12; and (D) an alignment member 59 configured to be mounted within the table top 12 and extend at least partially through a second aperture 34 in the plate of the coupler 16, the alignment member 59 preventing the rotation of the table leg assembly 14.

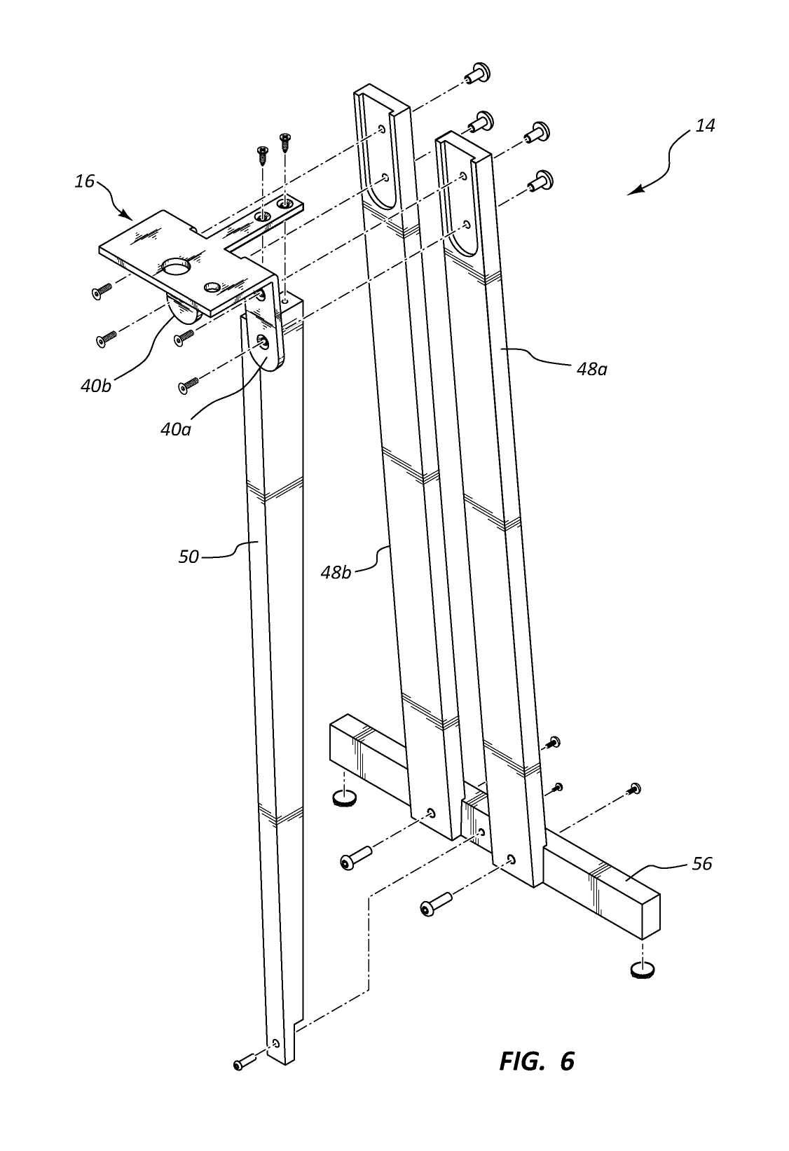

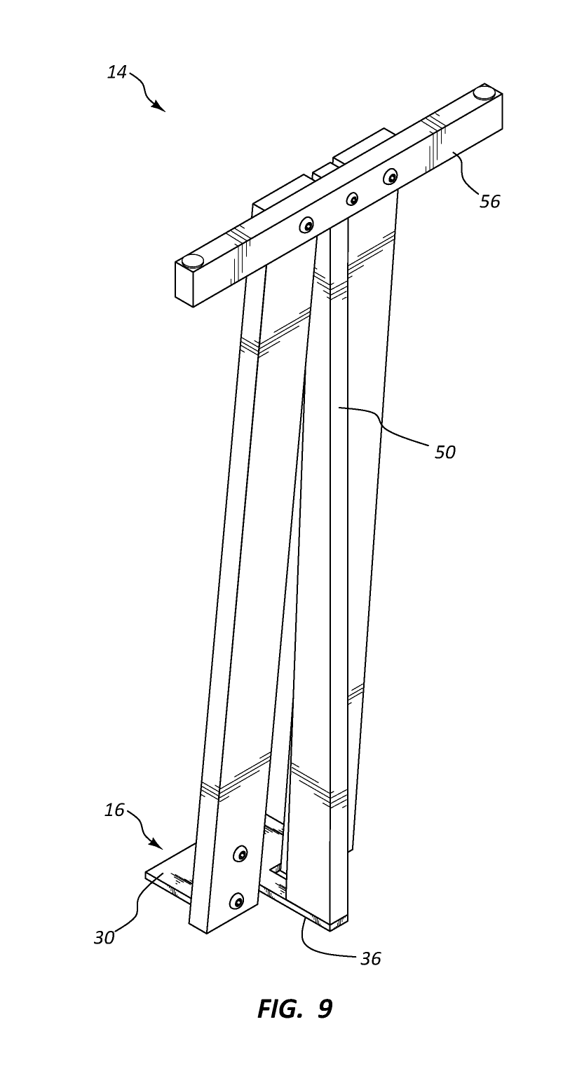

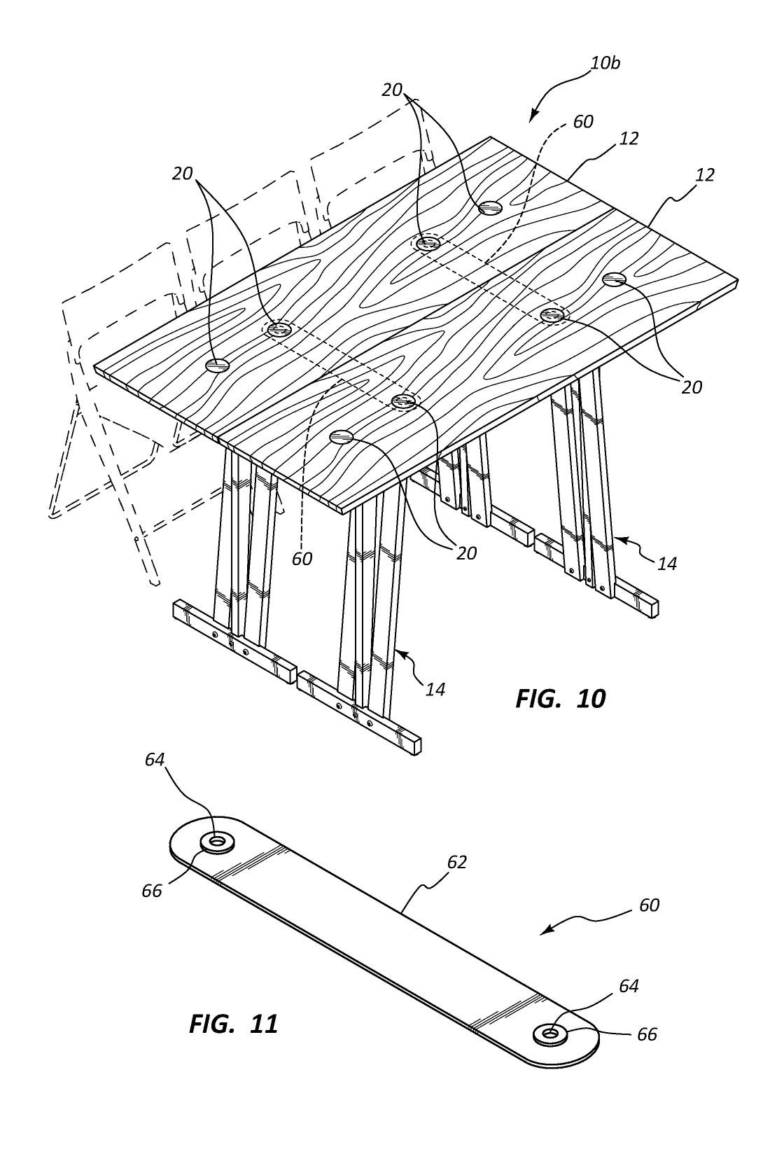

The table leg assembly 14 is further shown in FIGS. 6-9. As shown in FIGS. 6-9, flanges 40a and 40b of coupler 30 couple to respective parallel support legs 48a and 48b that extend from coupler 30 at an angle. Buttress leg 50 is coupled to buttress support 36 and is angled on one side thereof and therefore extends at an angle from buttress support 36. The parallel support legs have a passageway 52 therebetween. The buttress leg extends away from buttress support 36 in a manner that it eventually intersects or converges into the passageway 52 to between the parallel support legs 48a and 48b, so that legs 48a, 48b, and 50 eventually converge into the same plane (e.g., at leg support 56).

Thus, support legs 48a and 48b are spaced apart and buttress support leg 50 is partially within the space between the two support legs 48a and 48b and is partially not in the space 52 between the legs 48a and 48b. Support legs 48a, 48b and buttress leg 50 begin at coupler 30 and extend in a triangular relationship to a desired height and connect to floor support 56. Thus, support legs 48A, 48B and buttress leg 50 are connected at one end to coupler and at an opposing end to floor support member 56. The surfaces of floor support member 56 can be slightly angled, such that upon being mounted on the floor, the support member member 56 is flush with the floor. Floor support member 56 may have plastic or felt tabs or other material thereon in order to prevent scratching of the floor surface, and/or to prevent damage to floor support member 56.

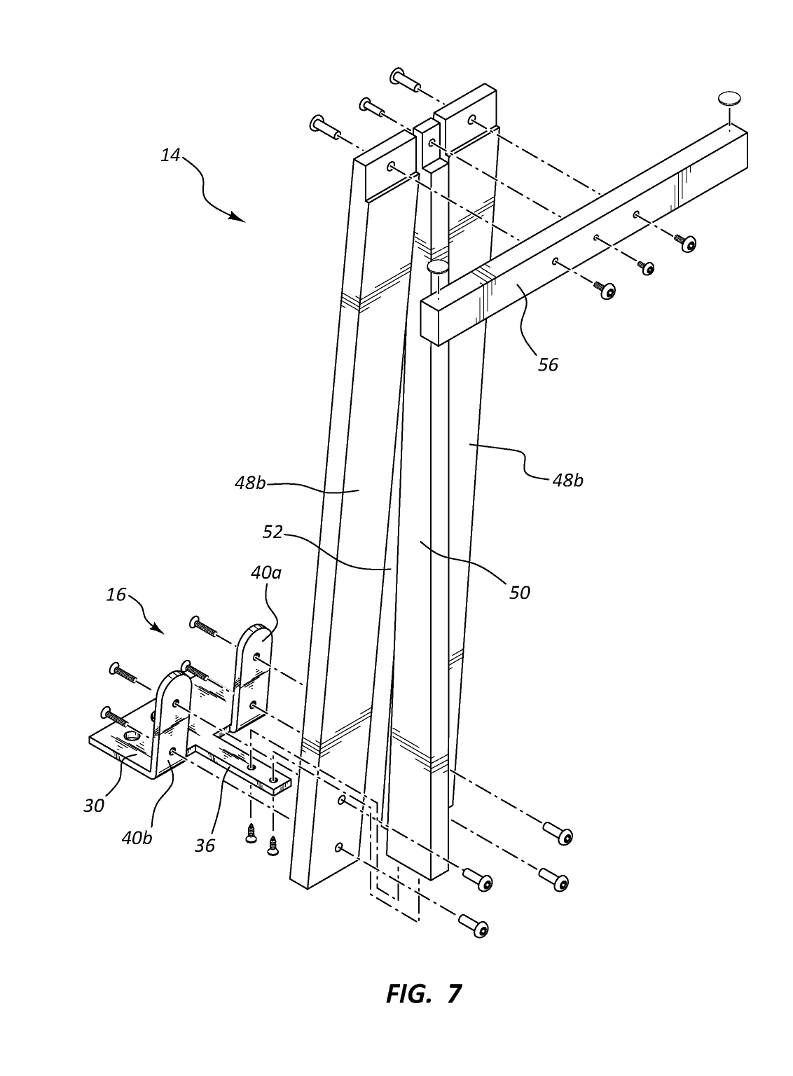

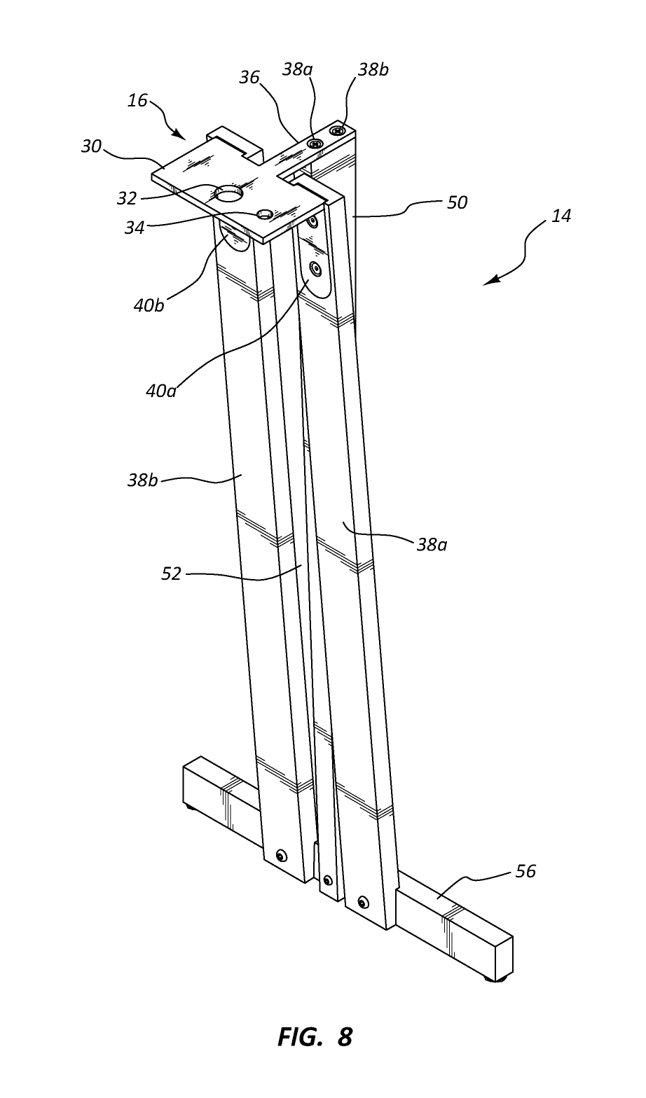

FIGS. 6-7 show exploded views of coupler 30, the floor support member 56, the legs 48a, 48b and buttress leg 50 that are mounted between coupler 30 and floor support member 56 using the attachment members shown. The connection of the legs 48a-48b and 50 between couplers 30 and floor support member 56 form a triangular relationship that creates a strong and reliable support member that can be mounted reliably between the table top and the floor.

The plate 30 of coupler 16 bears some of the weight of the table top 12 and the weight of the table top 12 is further extended upon the buttress support 36 and in some embodiments the ends of the legs 48a, 48b directly bear support of table top 12. All of the force of table top 12 is then directed in a triangular relationship along legs 48a, 48b and 50 down to floor support member 56. The surface area provided by the above components against table top 12 in a triangular relationship provides excellent support for the table, somewhat similar to a 3-legged stool, for example, but with the further advantages of being affixed to plate 30 that spreads the surface area out, providing additional support. The triangle formed at the coupler 16 provides a great deal of surface area upon which to mount the table top 12. The legs 48a-b and 50 of leg assembly 14 transfer force down to the floor support member 56.

The larger triangular configuration of the legs formed at coupler 16, as opposed to the tighter triangle at support member 56, shares the load of table top 12 more evenly spread across the larger triangle, thereby distributing the weight of table top 12. The legs funnel or converge down toward support member 56 into three concentrated pieces that are closer, and thereby easier to install at support member 56. Thus, leg assemblies 14 have the advantage of providing support to table top 12, yet are convenient to assemble at coupler 16 and support member 56.

The uniting of the three table legs onto the support member 56, as shown in FIGS. 6-9, allows convenient alignment of the table legs ends mounted on support member 56 on the same side of support member 56, making assembly convenient for the manufacturer. Table legs 48a-b, 50 may be notched in order to conveniently receive member 56 thereon, as shown in FIG. 7.

Thus, the table legs start at one end (e.g., at the table-top end) in a larger triangle for increased surface area support of the table top 12, then extend to a smaller triangle that is convenient to mount onto the support member 56 in the same plane of support member 56. The table leg assembly 14 thus comprises three table leg members, each having a top end that is mounted to a coupler 16 and configured to be placed adjacent the table top 12. Each of the three leg members having a bottom end that is mounted to a floor support member 56, wherein each of the bottom ends of the three leg members contacts the floor support member 56 along a longitudinal axis defined by the length of the floor support member 56 such that it is convenient to connect the bottom ends of the three leg members 48a-b, 50 to the floor support member 56. The top ends of each of the three leg members are spaced apart from each other on the coupler 16 to thereby increase the amount of surface area of the table top 12 supported by the top ends of the three table legs 48a-b, 50. The concept of the present invention employing a plurality of table leg assemblies, each in the triangular configuration mounted onto a table top in a variety of different triangular sizes and configurations thus has a variety of advantages.

An additional benefit of the table leg assembly 14 of the present invention is that it enables a coupler 16, e.g., a metallic coupler, to be coupled to an aesthetically pleasing wood material or other aesthetically pleasing material. In one embodiment the coupler 16 is one or more metallic materials and the legs are formed from a wood material, e.g. cherry, mahogany, walnut, maple, oak, etc. In one embodiment, legs 48a-48b and buttress leg 50 and floor support member 56 are comprised of a wooden material such as maple, or a variety of other materials that may be desired from a strength and aesthetic standpoint. Table top 12 can also be an aesthetically pleasing wood material to which couplers 16 are conveniently coupled.

In one embodiment, the nut members 20 are comprised of a steel material that is electroplated with copper for appearance and wear, for example.

Resilient isolators or felt-style pads mounted on the floor support member 56 prevent scratching of the floor surface, the isolators or pads being mounted on floor support members 56. In one embodiment, the leg members 48a-b are each approximately 29 inches long, but shorter legs can be used for benches or smaller tables.

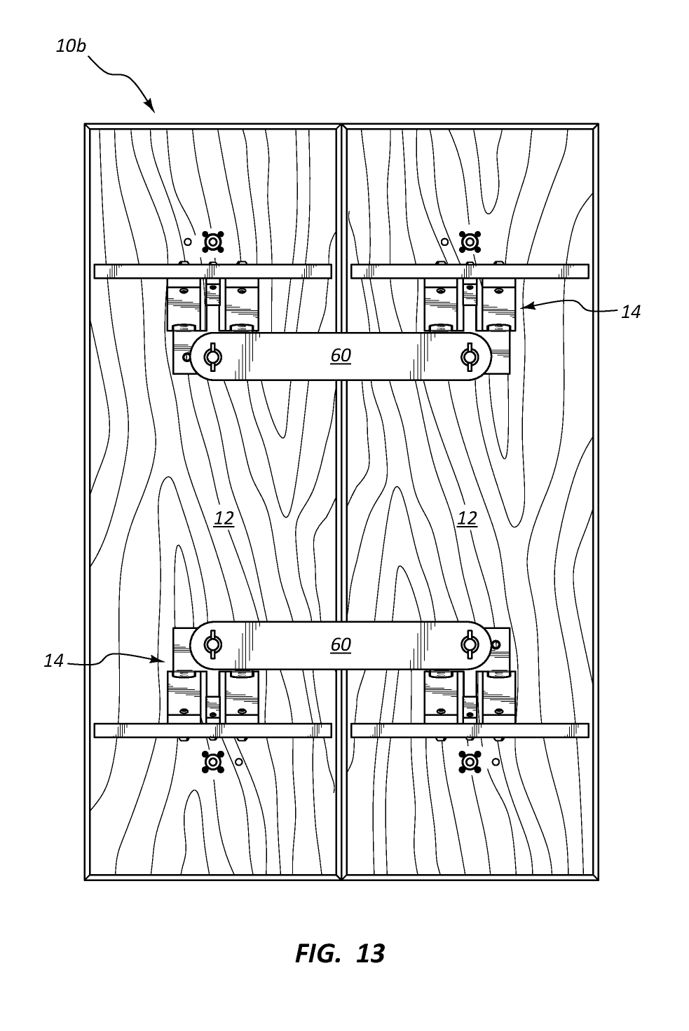

As discussed with respect to FIG. 1, respective holes 21a, 21b receive portions of respective mating two-part attachment members, wing screw 18 and nut member 20, there-through. Thus, holes 21a, 21b are configured to at least partially receive mating two-part attachment members 18, 20 therethrough. In another embodiment, alternate holes 23a, 23b may be employed in the event that it is desired to spread the leg assembly members 14 out further. The alternate holes 23a, 23b can also be conveniently used when connecting tables together as illustrated in FIGS. 12 through 13.

FIG. 10 shows that advantageously two tables 10 of FIG. 1 of the present invention can be selectively, modularly connected together via one or more table top connectors 60 to form a larger table, such as a standard size banquet table. For example, in one embodiment, each of the table tops 12 have dimension of approximately 15″ in width and approximately 72″ in length such that they form when combined a banquet table 10b as shown in FIG. 10 having dimensions of approximately 30″×approximately 72″. As shown in FIG. 10, it is convenient to place three chairs on one side of the banquet table 10b formed in FIG. 10 with each chair being able to be seated at the table 10b without significant interference from an associated table leg assembly. The present invention thus provides convenient coupling of tables 10 together to form a larger table 10b.

Tables of the present invention, such as tables 10 are connected together by connecting the table tops 12 to each other. In order to connect the table tops 12 together, one or more table top connectors 60 are used, such as illustrated in FIG. 11. Table top connectors 60 are each comprised of a substantially flat plate 62, having first and second apertures 64 therein. Each of the apertures are a passageway through plate 62 and through a circular neck 66 that extends out of plate 62.

Necks 66 of connector 60 may be approximately 1/16 inch in width, for example, and are configured to fit conveniently within the recessed spaces 67 within respective plates 30 of couplers 16 that are mounted on respective necks 25 of nut members 20 adjacent table tops 12, as illustrated in FIGS. 12 and 13.

As illustrated in FIGS. 12 and 13, in one embodiment, when plates 30 of couplers 16 are placed on the underside of table tops 12 onto the neck portions 25 of the nut members 20, a recessed space 67 (e.g., 1/16^{th} of an inch) exists between the surface of the plates 30 and the surfaces of the necks 25 of corresponding nut members 20. Thus, the necks 25 of the nut members 20 are embedded deeper within the plate 30 than the surface of the plate 30, forming the recessed spaces 67 shown in FIG. 12.

This recessed space 67 between necks 25 and plate 30 can be filled in mating relationship by the necks 66 of the table top connector 60, when connector 60 is selectively mounted in nesting relationship on adjacent plates 30 as illustrated in FIGS. 12 and 13, such that the necks 66 of connector 60 are mounted in mating relationship within the recessed spaces 67 between the neck members 25 of the nut members 20 and the surface of plate 30.

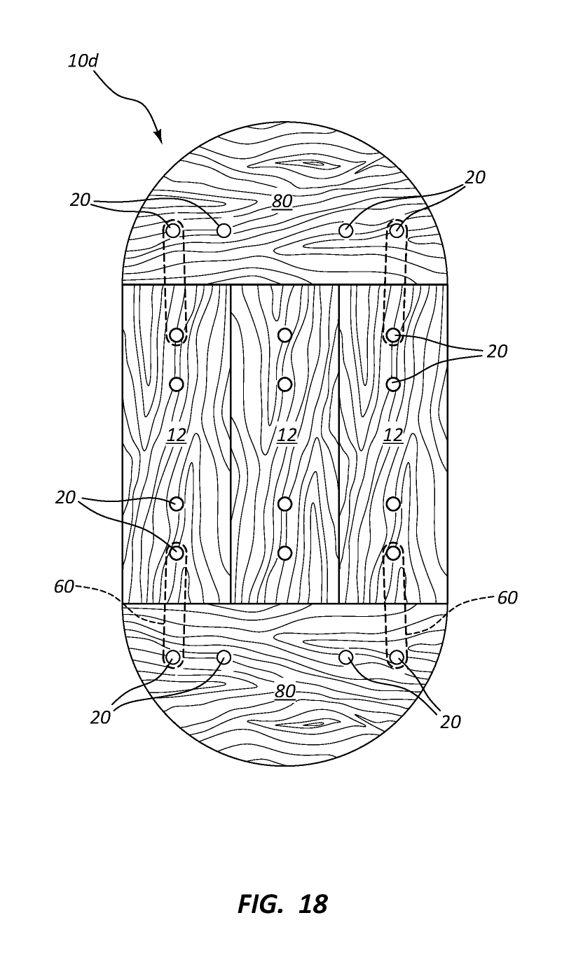

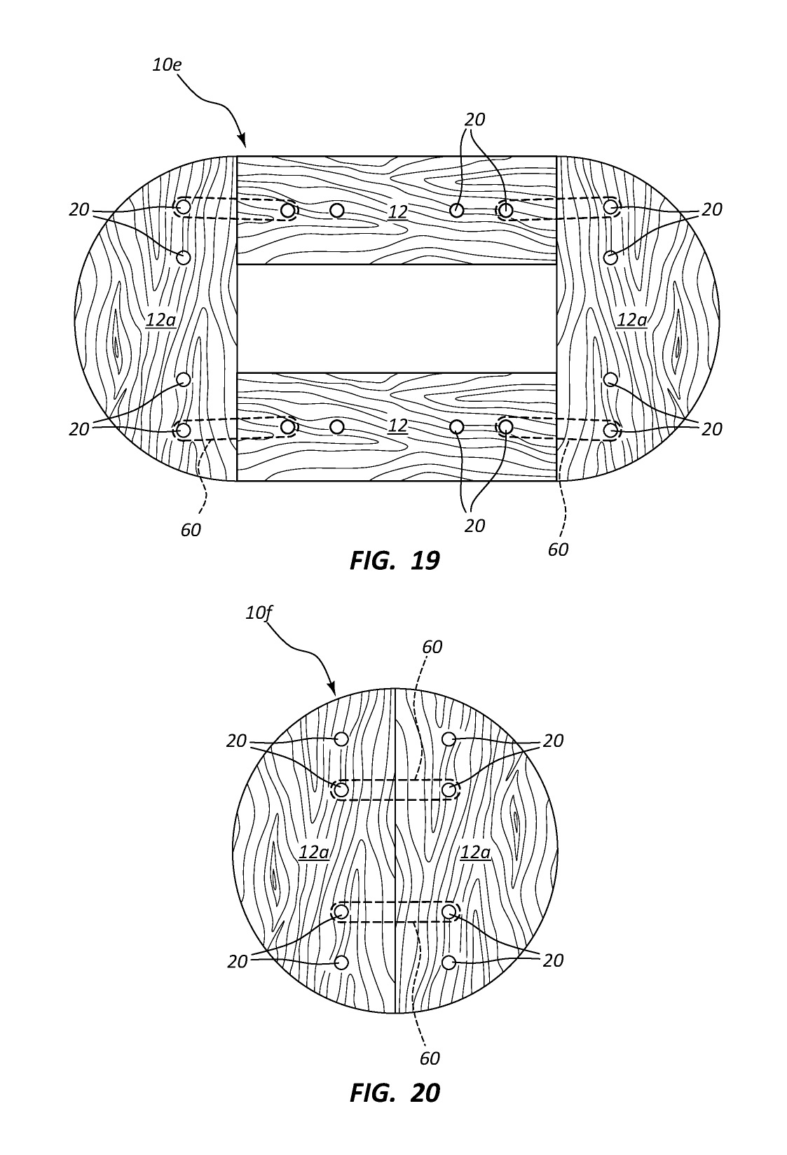

Selectively placing the necks of the connectors 60 in the recessed spaces 67 formed between adjacent table tops helps to properly orient and secure couplers 60 with respect to adjacent couplers 16, as show in FIGS. 12 and 13. Placing the necks of the couplers 60 in the recessed spaces 67, then coupling the wing screws 18 into the necks 25 of corresponding nut members 20 connects table tops together, as illustrated in FIGS. 12-14 and 17-21. Thus, the configuration of connector 60 shown in FIGS. 12-13 with its necks 66 extending out of a plane of plate 62 is advantageous in that connector 60 conveniently orients flush on top of plates 30 as shown in FIGS. 12-13. Once wing screws 18 are then mounted through respective apertures 64 of connector 60, through plates 30 of couplers 16 and into the necks 25 of nut members 20, table tops 12 are reliably connected to each other, as shown in FIGS. 12-13.

Thus, as shown in FIGS. 12-13, plates 30 of couplers 16 are selectively mounted in mating relationship onto neck members 25 of respective nut members 20. This mating relationship provides further stability to leg assemblies 14 as they are mounted on table tops 12. As further shown in FIGS. 12-13, connector 60 selectively mounts and nests in mating relationship onto plates 30 of leg assemblies 14 on adjacent taps tops 12 in order to connect the table tops 12 to each other.

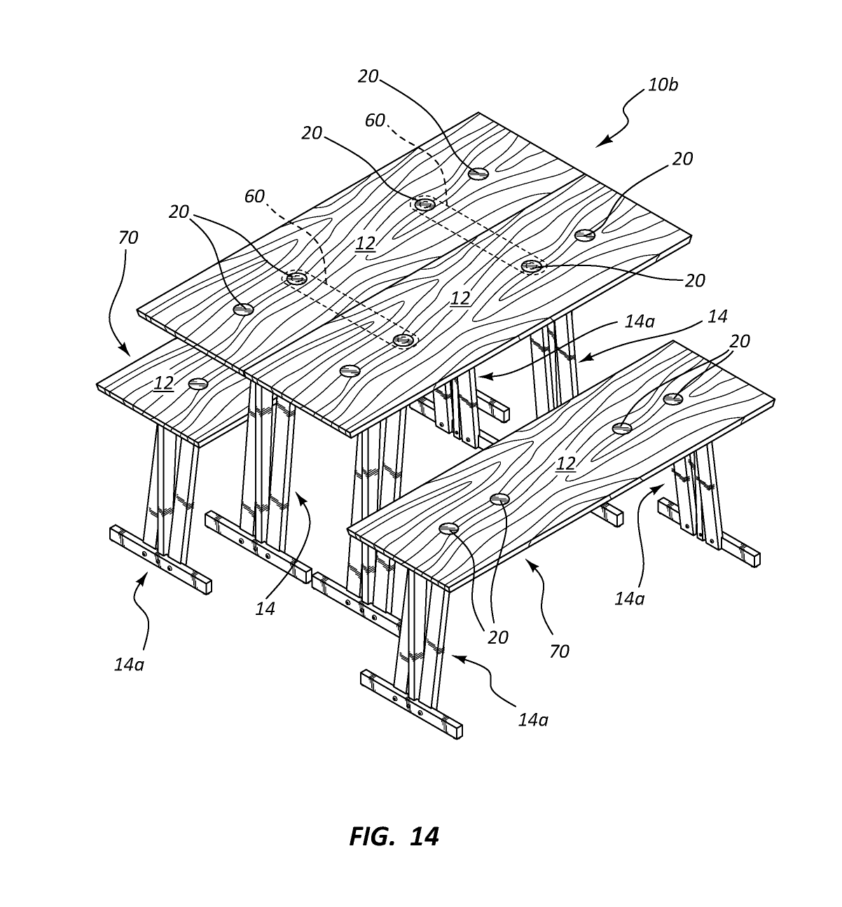

FIG. 14 illustrates another advantage of the present inventions which is the configuration of a table top 12 of the present invention being able to be used as either a table top 12 or as a bench seat 12. As shown in FIG. 14, two combined table tops 12 are used for forming the table top portion of the banquet table 10b while another table top 12 having the same configuration and dimensions is separately used as a bench. In the bench of FIG. 14, the leg assemblies 14a are the same basic configuration and design as leg assemblies 14 of FIGS. 1-13, except that bench leg assemblies 14a are shorter. Thus, in one embodiment, the design of the approximately 15-inch by approximately 72-inch table top 12 of the present invention can be used either as a bench or as a table top, depending only upon the size of the leg assemblies (14 or 14a) employed to hold the table top 12. The leg assemblies may be either approximately 29.5 inches long for table leg assemblies 14, for example, or approximately 17.5 inches long for bench legs 14a, for example.

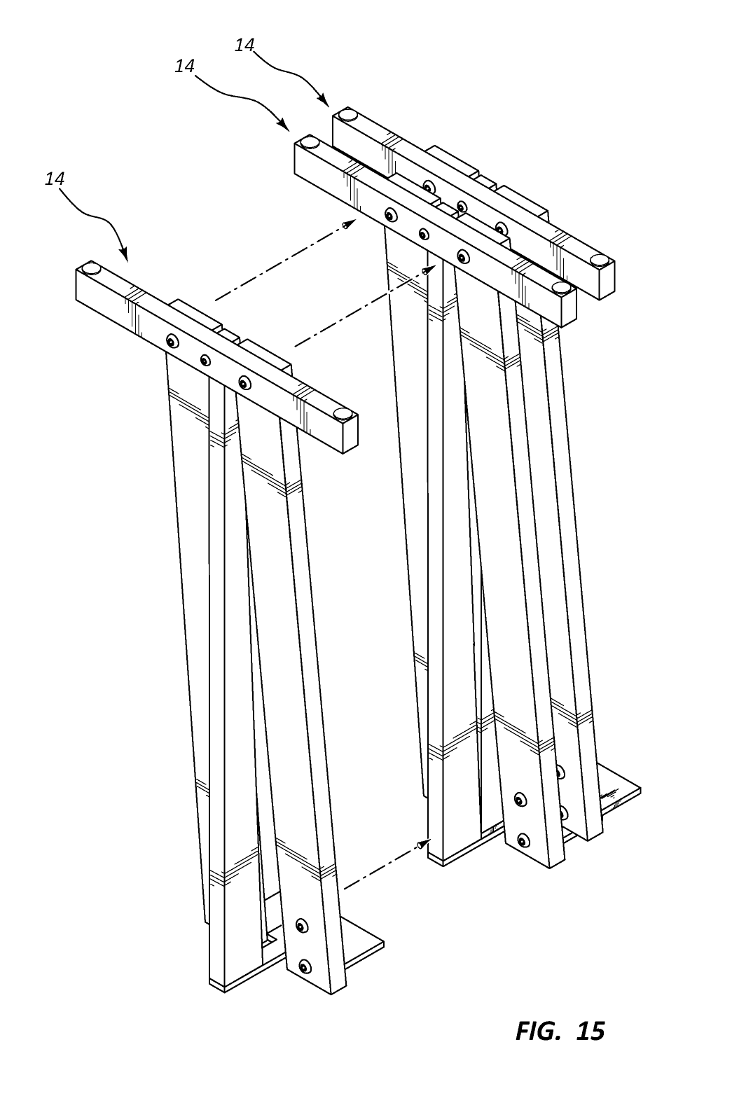

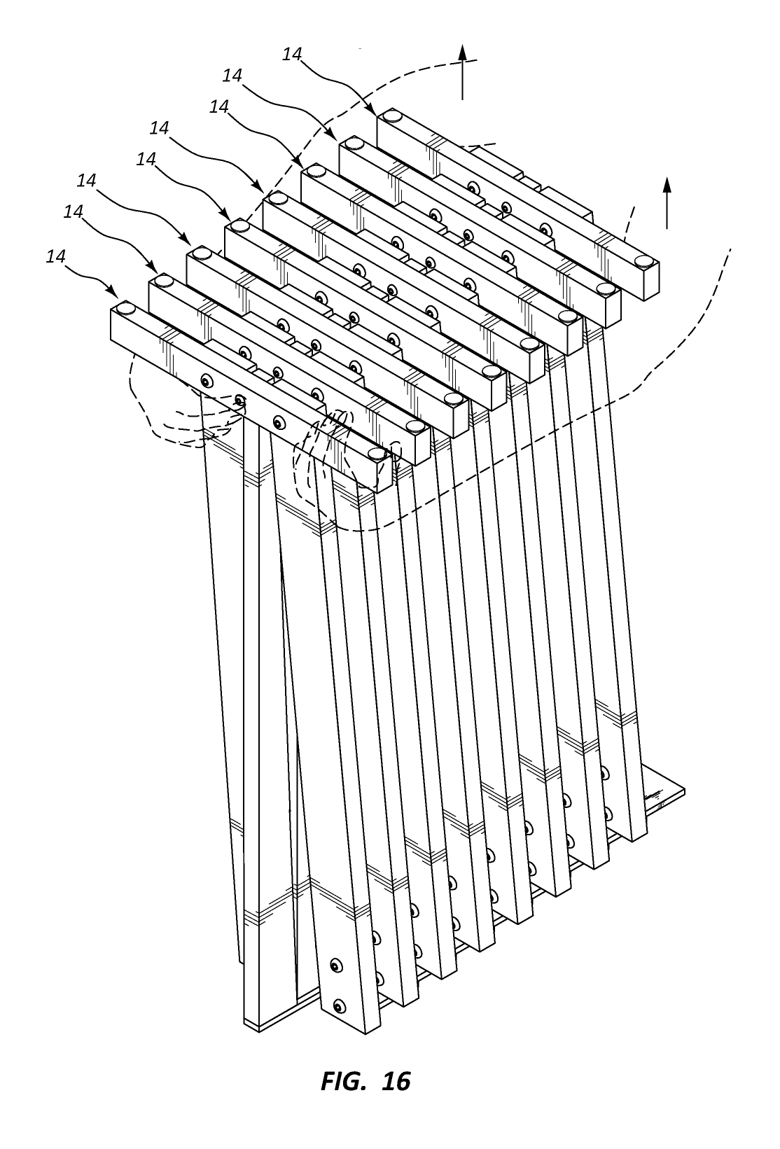

FIGS. 15 and 16 show the convenient nesting relationship achieved by leg assemblies 14. In light of the shape of coupler 16 and the relationship of the legs 48a-b and 50, leg assemblies 14 conveniently nest into each other such that they can be conveniently hefted and carried. As shown, convenient nesting is a function of buttress support 36 and the space 52 formed between leg members 48a-b. Buttress leg 50 does not initially extend within space 52 between leg members 48a-b, but then eventually extends into the space 52 as buttress 50 moves away from the buttress support 36, towards floor support member 56. As shown, one buttress leg 50 conveniently nests onto the buttress support 36 of an adjacent assembly 14. The nested leg members are conveniently carried by the floor support member 56 in an upside-down relationship as shown in FIG. 16 with the user draping the user's arms under multiple adjacent floor support members 56 for convenient carrying as shown in FIG. 16.

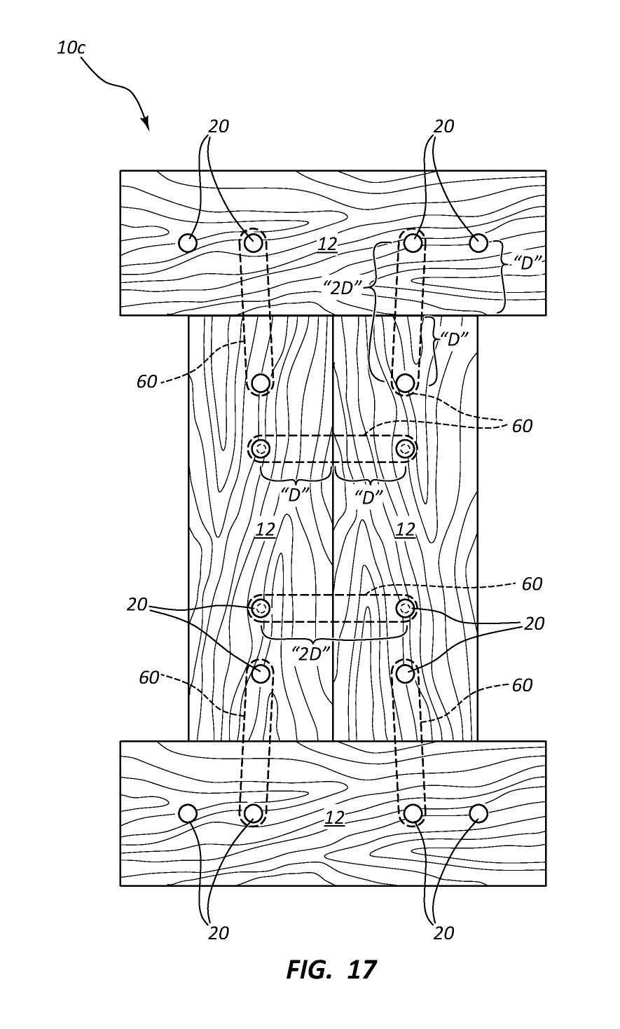

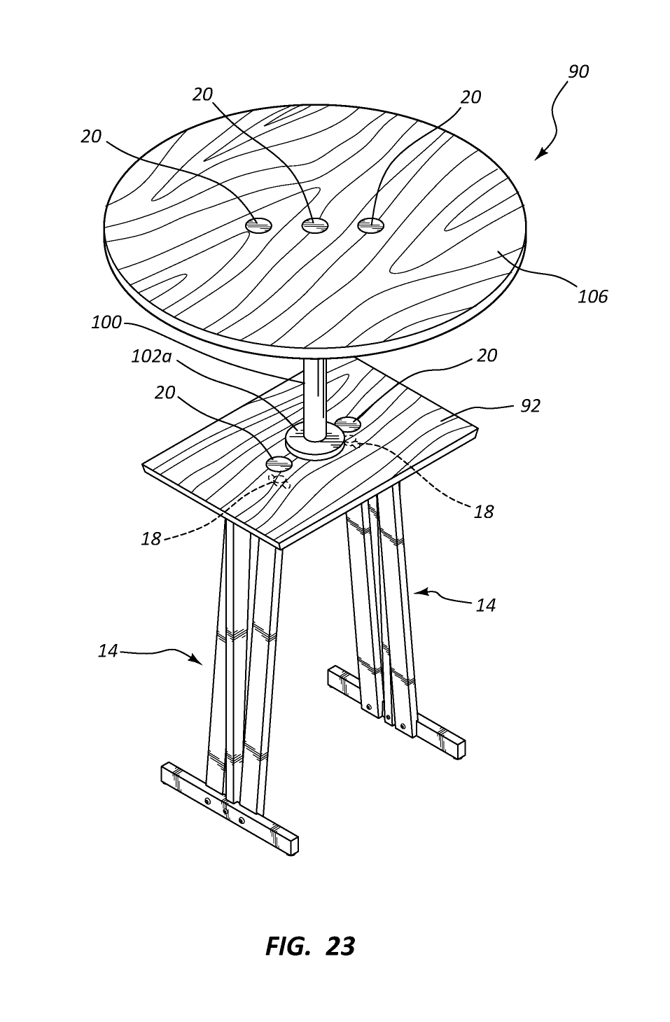

FIGS. 17-21 show convenient configurations of tables 10c-g of the present invention that are formed by coupling a plurality of table top connectors 60 to adjacent table tops, e.g., table tops 12 and other table tops described herein having a variety of different shapes and dimensions. FIGS. 22-23 further show a rotating serving table, e.g., a Lazy-Susan style rotating serving table that can also be used in connection with the table leg assemblies 14 of the present invention. These figures demonstrate the versatility of the design of table leg assemblies 14.

In one embodiment, a table top 12 is approximately 15 inches in width and approximately 45 inches in length and approximately an inch in thickness, and the leg assembly 14 is 29 inches high, which when mated with the one-inch thick table top creates a 30-inch-high table. In another embodiment, the table top is approximately ¾ inch in thickness and the leg assembly is approximately 29¼ inches in height, for example. A variety of other sizes and dimensions may be employed with table leg assemblies 14. The present invention enables a variety of modular positions and changeable options that are available using the table leg assembly and the table top of the present invention as coupled by the unique couplers and attachment members of the present invention.

In one embodiment, a user can use a set of leg assemblies 14 approximately 29.5 inches in height and any of table tops comprised of a half-moon shape, a 15 inches×72 inches, a 15 inches×45 inches, a 30-inch round, a 36-inch round and any combinations of any of those shapes to achieve whatever shape and function may be desired.

For example, in one embodiment, a standard size for a banquet table is 30 inches in width by 72 inches in length. In one embodiment, as illustrated in FIGS. 10-14, the table top 12 of the present invention is approximately 15 inches in width by approximately 72 inches in length and when combined with a table top 12 of identical dimension, the two table tops 12 collectively form a standard banquet table 10b having a width of approximately 30 inches and a length of approximately 72 inches.

In one embodiment, nut members 20 in FIGS. 1-4, 10-14, and 17-23 are positioned at a universal offset distance “D” from at least one edge of the table tops 12 on which they are mounted. By placing nut members 20 at a universal offset distance (e.g., approximately 7.5 inches) from a side edge and/or end edge of a corresponding table tops 12, a variety of table configurations can be aligned by coupling the table tops 12 together using connector 60, as shown in FIGS. 17-21. For example, if a user wants a table to be 12 feet long, two six-foot table tops can be coupled together.

So long as the nut members 20 are the universal offset distance “D” from each edge, a variety of convenient connection combinations are possible. For example, when the nut members 20 are 7.5 inches from each edge, there is a 15-inch connector distance (twice the offset distance, i.e., 2D). A connector 60 having a hole 64 to hole 64 length of 15 inches can conveniently couple the adjacent nut members 20 having a 7.5-inch offset distance “D” to each other as shown in FIGS. 17-21.

In one embodiment, a table top having a first nut member 20 that has a 7.5-inch offset distance “D” from an edge can readily connect to other table tops having nut members that are also 7.5 inches offset distances “D” from their respective table top edges, thereby allowing a variety of different coupling options using connectors 60 with a connector distance of 15 inches, such as shown in FIGS. 12-21. Importantly, the connectors 60 can be connected to certain nut members 20 that are also being used for connections to leg assemblies 14, but connectors 60 can also be connected to nut members 20 that are not currently being used for connections to leg assemblies 14.

The connectors 60 and the universal offset distances “D” between nut members 20 and table edges provide a variety of different advantages. For example, as shown in FIG. 10, in one embodiment on a 30 inch by 72-inch table 10b with table leg assemblies 14 mounted in nut members 20, three chairs can fit conveniently at the table 10b without significant leg interference from the table leg assemblies 14. In this embodiment two 72″×15″ table tops 12 are connected next to each other, forming a standard banquet table and easily having three chairs on one side and potentially three opposing chairs on the other side. However, in order to change the seating, e.g., for the convenience of the person(s) sitting on the end, in one embodiment, a 45″ by 15″ table top is added to form the table 10c, as shown in FIG. 17.

In FIGS. 17-21 each of the table tops has at least one an attachment member located at a universal offset distance “D” from an edge of the respective table top and wherein the table top connector 60 has a length of at least 2D to thereby span adjacent table edges to connect adjacent table tops together, the table top connector configured to be mounted on attachment members of adjacent table tops.

A variety of other advantages can be achieved using the connectors 60 of the present invention and employing universal offset distances “D” between table tops.

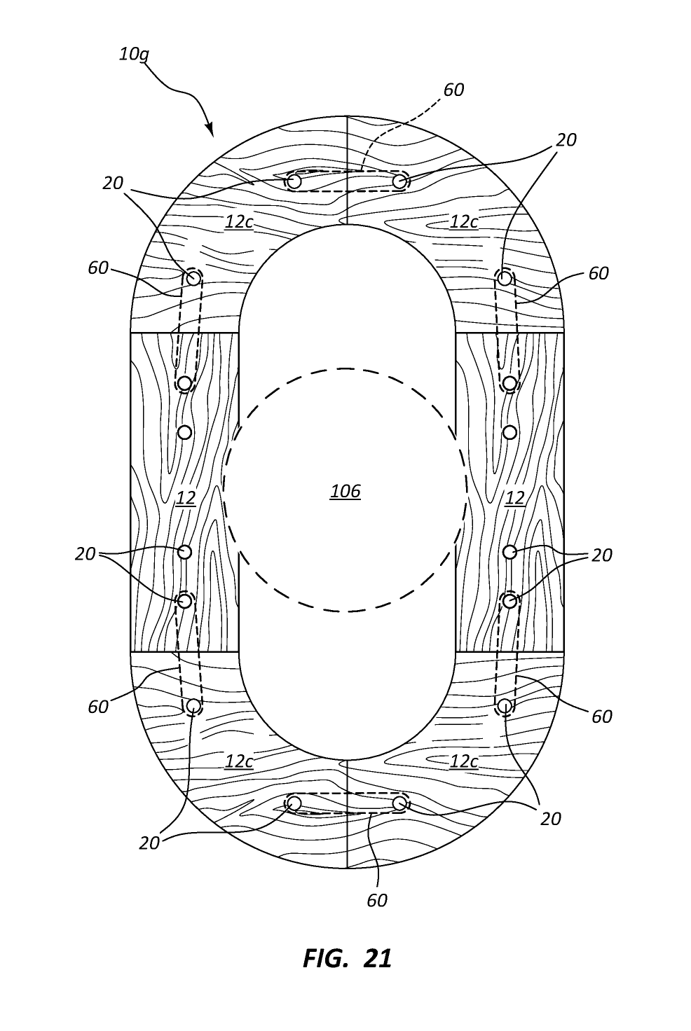

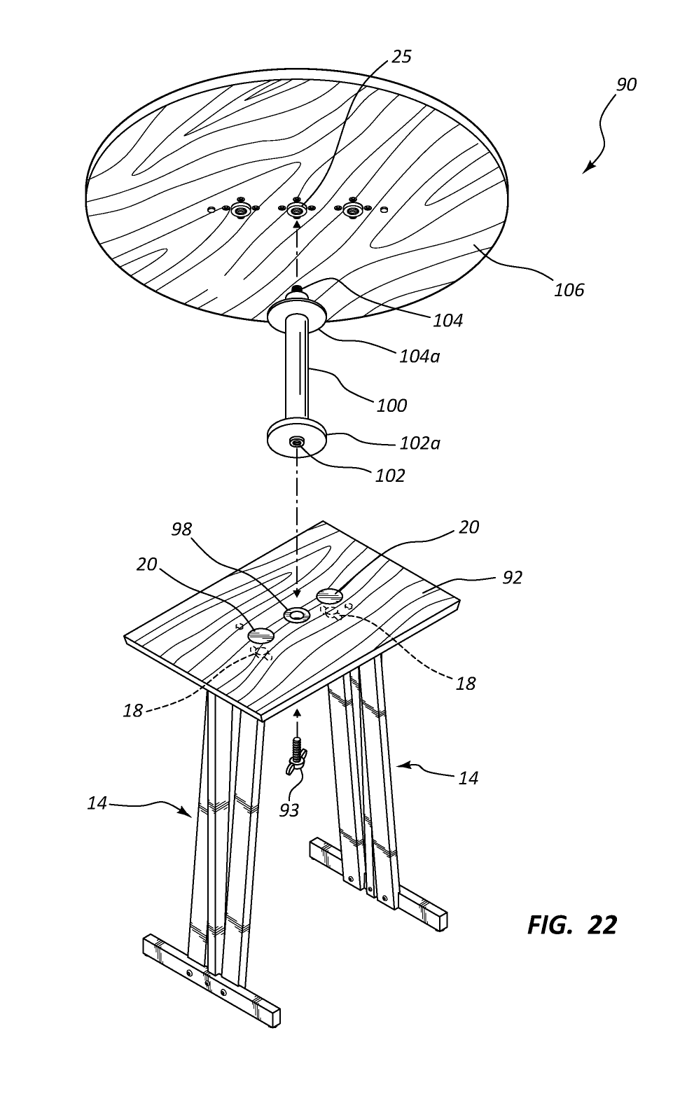

FIGS. 21-23 further show a rotating serving table 90 that can be formed using the shorter table leg assemblies 14 of the present invention and/or additional components clarified herein. Rotating serving table 90 is formed using table leg assemblies 14, an upper table top 106, and an intermediate table top member 92 having a smooth bore hub member 98 (e.g., a metallic hub member 98) therein into which a spinning extension member 100 can be rotatably mounted.

Spinning extension member 100 has, at a bottom end, a smooth outer bore neck 102 with internal threads that can be connected to an attachment member such as a wing screw 93 extending through hub 98 into neck 102. Neck 102 is selectively placed in mating relationship within hub 98, as illustrated in FIG. 22. A connector 104 at a top end of extension number 100 selectively connects to upper table top 106, which may be circular in nature. The outer smooth bore neck 102 at the bottom of extension member 100 rotates with hub 98. Thus, a Lazy Susan style rotating serving assembly may be formed as shown in FIGS. 22-23.

As further shown in FIG. 21, the Lazy Susan style rotating serving assembly may be placed within the middle of a table assembly 10g of the present invention and may serve various individuals in a banquet style using a rotating table top 106. Table leg assemblies 14 are connected to intermediate table top 92 in a similar way as discussed with respect to table 10 in FIGS. 1-9, for example.

In one embodiment, the hole in the table 10g, as shown in FIG. 21, is used for the placement of pedestals that hold flower arrangements and/or Lazy Susan type serving trays for decorative, functional and/or interesting displays, e.g., wedding or other banquet purposes.

FIGS. 21-23 and the disclosure herein illustrates that the principles of the present invention can be used to make serving tables, bistro tables, and cocktail-style tables as desired. In one embodiment, rather than rotating, the extension member 100 can be immovably coupled to table 92 to form a cocktail style table, for example.

In one embodiment, hub 98 is a metallic non-threaded hollow member mounted within intermediate table top 92 and receives neck 102 therein. Neck 102 rotates within hollow non-threaded hub 98, in one embodiment. Wing screw 93 maintains neck 102 within hub 98 and assures that extension member 100 remains mounted on table top 92. Hub 98 may have an internal circular hollow shoulder upon which the lower circular edges of neck 102 rotate when being rotated.

Thus, in one embodiment, extension 100 is rotatably coupled to intermediate table 92 by having neck 102 rotatably coupled to hub 98 using wing screw 93, which extends through hub 98 into the internal threads within neck 102.

In another embodiment, the hub of table 92 is a nut member that the extension member threads into, or some other form of non-rotating connection between extension 100 and table top 92.

As another option, in one embodiment the upper table top 106 is rotatably connected to an upper portion of an extension member of the present invention.

In one embodiment, a circular or rectangular table of the present invention is set at a coffee table at coffee table height of approximately 24 inches for example, or at 30 inches to be a bistro table for example or at 36 inches to be a working table. At 45 inches height a table of the present invention could be a cocktail table. A standard desk using the leg assemblies and table tops described herein might be 36 inches in height for example.

The outwardly extending circular disk shaped members 102a-104a of the extension member 100 shown in FIGS. 22-23 are wider than the handle portion. The wider outwardly extending circular disk shaped members 102a-104a mounted on the handle of extension member 100 provide stability as well as convenience for gripping when in use (e.g., during rotation of member 100) and during set up and removal.

As shown in FIGS. 22 and 23, circular disk shaped members 102a, 104a mounted on the handle of extension member 100 provide stability to extension member 100 and to the resulting table assembly 90 in which extension member 100 is used. In one embodiment, one or both of the circular disk shaped members contacts the table top adjacent to which is it placed, thereby providing further stability to the overall table in which extension member 100 is used. For example, as shown in FIG. 23, in one embodiment, lower circular disk shaped member 102a of extension member 100 (which is adjacent neck 102) is mounted on intermediate table top 92 (e.g., slidably mounted on table top 92), thereby providing additional stability to table 90. The upper circular disk shaped member can also be configured to contact the upper table top 106, thereby providing stability to the table top 106 and the overall table. However, in another embodiment, one or both of the disk shaped members do not necessarily contact the adjacent table tops.

Importantly, all of the table tops, couplers, connection members, and leg assembly pieces discussed herein can be conveniently placed into a closet or other storage areas when not in use. Thus, inventions described herein can be described as “seating for X in your closet,” wherein X could be as many as 16 people or more, for example.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A table leg coupler comprising:
a substantially flat plate, having an aperture therein, the plate having a first side and a second side;
first and second flanges extending from opposing ends of the first side of the plate; and
a buttress member extending outwardly from the first side of the plate between the first and second flanges, the buttress member extending outwardly from the plate in the same plane as the plate,
such that the plate and the buttress member can be mounted flush with a substantially flat bottom surface of a table top,
such that first and second parallel table support legs can be supported by the first and second flange members, respectively, and
such that the buttress member supports a buttress leg that is offset from the first and second table support legs.

2. A coupler as recited in claim 1, wherein the aperture is configured to at least partially receive mating two-part attachment members of a tabletop therethrough.

3. A coupler as recited in claim 1, wherein the buttress leg is oriented transversely with respect to the parallel support legs.

4. A coupler as recited in claim 1 wherein the plate has a second aperture therein for securing the plate on an alignment member in a selective orientation with respect to the table top.

5. A coupler as recited in claim 4, wherein the alignment member is a screw.

6. A coupler as recited in claim 1, wherein the coupler is a metallic coupler.

7. A coupler as recited in claim 1, wherein the first and second flanges are threadably mounted onto the first and second support legs respectively.

8. A coupler as recited in claim 1, wherein a first attachment member is configured to be mounted into the table top of a table, the first attachment member configured to extend through the primary aperture of the coupler to thereby attach to a second attachment member that is selectively attached thereto, coupling the table top to the coupler.

9. A coupler as recited in claim 8, wherein the first attachment member is a nut member and the second attachment member is a wing screw that selectively threads into the nut member.

10. A coupler as recited in claim 1, wherein the flanges are angled approximately ninety-two to approximately one hundred five degrees away from a plane defined by the plate.

11. A coupler as recited in claim 1, wherein the flanges are angled approximately ninety-five to approximately ninety-nine degrees away from a plane defined by the plate.

12. A coupler as recited in claim 1, wherein the flanges are angled approximately 97 degrees away from a plane defined by the plate.

13. A coupler as recited in claim 1, wherein the flanges are angled 97 degrees away from a plane defined by the plate.

14. A coupler as recited in claim 1, wherein the coupler is selectively mounted onto a mounting nut having a neck and a shoulder, the shoulder being mounted on the neck and being wider than the neck, the mounting nut being configured to extend through a table top such that the aperture of the plate of the coupler can be mounted about a portion of the neck that extends through the table top and such that an attachment member is selectively coupled to the neck of the mounting nut.

15. A coupling assembly for coupling table legs to a substantially flat table top, comprising:
(A) a mounting nut configured to be secured to the table top, the mounting nut having a neck and a shoulder mounted about the neck, the neck configured to extend through a portion of the table top such that a portion of the neck of the mounting nut extends out of a surface of the table top;
(B) a coupler having a substantially flat plate, the coupler further having first and second opposing flanges extending from opposing portions of a first side of the plate, the first and second flanges extending at an angle away from a plane defined by the substantially flat plate, the coupler further having a buttress support member extending between the first and second flange members outwardly away from the plate within the same plane as the plate, the coupler further having an aperture through which the neck of the mounting nut at least partially extends; and
(C) an attachment member that selectively, removably extends into the neck of the mounting nut, thereby selectively, removably connecting the coupling plate of the coupler to the mounting nut, such that the table leg assembly is coupled to the table top.

16. A coupling assembly as recited in claim 15, further comprising an alignment member configured to be mounted within the table top and extend at least partially through a second aperture in the plate of the coupler, the alignment member preventing the rotation of the table leg assembly.

17. A coupling assembly as recited in claim 16, wherein the nut member is configured to be at least partially embedded within the table top.

18. A coupling assembly as recited in claim 17, wherein the flanges and buttress support member are configured such that table legs of the table assembly are mounted on respective flanges and the buttress support member.

19. A coupling assembly as recited in claim 18, wherein the attachment member comprises a wing-screw.

20. A table leg assembly configured to be mounted onto a table top to thereby form a table, the table leg assembly comprising:
first and second parallel table leg support members spaced apart from each other;
a buttress table leg support member oriented transversely with respect to the first and second parallel table leg support members; and
a floor mount member, wherein the first and second parallel table leg support members are mounted onto the floor support member with the transverse buttress table leg support member mounted onto the floor mount member between the first and second table leg support members, wherein the floor support member is oriented substantially transversely to the first and second table leg support members and to the transverse buttress table leg support member, such that the parallel support members and the transverse buttress table leg support member extend away from the floor support member.

21. A table leg assembly as recited in claim 20, wherein each of the parallel table leg support members and the transverse buttress table leg support member have a notch in a lower portion thereof, the floor support member being mounted within the notches of the parallel support members and the transverse buttress table leg support member, the parallel support members and the transverse buttress table leg support member each being mounted adjacent each other on the same side and edge of the floor support member.

22. A table leg assembly as recited in claim 21, wherein the floor support member has cushioning members thereon to prevent scraping of the floor surface.

23. A table leg assembly as recited in claim 20, wherein the floor support mount is connected to the parallel support members and the transverse buttress table leg support member on one end of the members and a coupler for coupling the table leg assembly to a table top is mounted at an opposing end of the parallel support members and transverse buttress table leg support member.

24. A table leg assembly configured to be mounted to a table top in order to form a table, the table leg assembly comprising:
a floor support member;
first and second parallel leg support members connected to and extending away from the floor support member;
a transverse buttress leg support member coupled to the floor support member between the first and second parallel leg support members and extending away from the floor support member;
a coupler connected at an opposing end to the parallel leg support members and the transverse buttress leg support member such that the parallel leg support members and the transverse buttress leg support member are connected at one end thereof to the floor support member and at opposing ends thereof to the coupler, wherein a portion of the transverse buttress leg support member extends between parallel leg support members at one end thereof and does not extend between the parallel leg support members at an opposing end thereof, such that there is a space between the parallel leg support members at the opposing end thereof.

25. A table leg assembly as recited in claim 24, wherein the table leg assembly is configured such that a second table leg assembly having an identical configuration can conveniently nest within the space between first and second parallel leg support members, for convenient storage of the table leg assemblies.

26. A table leg assembly as recited in claim 25, wherein the first and second table leg assemblies are selectively mounted onto a table top such that the table leg assemblies form convenient, stable legs in order to receive and support the table top thereon.

27. A table as recited in claim 24, wherein the support members of each of the table leg assemblies extend at an angle with respect to the table top when the table top is mounted on the table top leg assemblies.

28. A table leg assembly, comprising:
three table leg members, each having a top end that is mounted to a coupler and configured to be placed adjacent a table top and each of the three leg members having a bottom end that is mounted to a floor support member, wherein each of the bottom ends of the three leg members contacts the floor support member along a longitudinal axis defined by the length of the floor support member such that it is convenient to connect the bottom ends of the three leg members to the floor support member;
wherein the top ends of each of the three leg members are spaced apart from each other on the coupler in a triangular arrangement to thereby increase the amount of surface area of the table top supported by the top ends of the three table legs; and
wherein the top ends of each of the three support legs are spaced further apart from each other than the bottom ends of the three support legs, thereby providing increased surface area for proving support to the table top while making it convenient to connect the bottom ends to the floor support since they are close to each other while being mounted on the floor support.

29. (canceled)

30. (canceled)

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. (canceled)

44. (canceled)

45. (canceled)

46. (canceled)

47. (canceled)

48. (canceled)

49. (canceled)

50. (canceled)

51. A modular table assembly, comprising:
a substantially flat table top;
a plurality of attachment members connected to the table top; and
a plurality of table leg assemblies that are selectively mounted onto the table top.

52. A modular furniture assembly as recited in claim 51, wherein the leg assemblies conveniently nest into each other for storage.

53. A modular furniture assembly as recited in claim 51, wherein the leg assemblies each comprise a coupler and three leg members.

54. A modular furniture assembly as recited in claim 53, wherein the three leg members form a larger triangle at the ends at which the leg members are coupled to the coupler and a smaller triangle at the opposing ends thereof, at which they are coupled to a floor support member.

55. A modular furniture assembly as recited in claim 51, wherein each of the leg assemblies comprises a coupler that has first and second flanges that are angled with respect to a plane of a plate of the coupler and a buttress support member that extends away from the plate in the same plane as the plate.

56. A modular furniture assembly as recited in claim 56, wherein the uniting of the three table legs of each of the table legs onto a floor support allows convenient alignment of the table legs ends mounted on the same side of the floor support, making assembly convenient.

57. (canceled)

58. (canceled)

59. (canceled)

60. (canceled)

61. An assembly as recited in claim 51, wherein a buttress leg of one table leg assembly conveniently nests onto the buttress support of an adjacent table leg assembly for convenient storage.

62. An assembly as recited in claim 51, wherein assembly of the components does not require any tools such as screwdrivers, hammers, or the like but can be easily accomplished completely by hand.

63. (canceled)

64. An assembly as recited in claim 51, wherein the leg assemblies are selectively mounted at angles to the table top, thereby providing stability and reliability to the table assembly.

65. (canceled)

66. (canceled)

67. (canceled)

68. (canceled)
